(19) United States
(12) Patent Application Publication
(10) Pub. No.: US 2011/0167728 A1
(43) Pub. Date: Jul. 14, 2011

(54) Expandable Side Enclosure for Bathtubs/ Showers

(76) Inventor: Ilya G. Alelov, Briarwood, NY (US)

(21) Appl. No.: 13/004,058

(22) Filed: Jan. 11, 2011

Related U.S. Application Data
(60) Provisional application No. 61/282,270, filed on Jan. 12, 2010.

(51) Int. Cl. E05D 15/08; E06B 7/28

(52) U.S. Cl. 49/70; 49/130

(57) ABSTRACT

An expandable side enclosure for bathtubs and/or showers providing an appropriate solution to prevent restriction and suffering caused bathers in bathtubs and/or showers due to the lack of free body and limb movement required during bathing in baths with standard enclosures.

### CROSS-REFERENCE TO RELATED APPLICATIONS

This application claims the benefit of U.S. Provisional Application No. 61/282,270, filed Jan. 12, 2010, which is incorporated herein by reference.

### THEORETICAL CONCEPT

### A. Technical Field

Today, it is customary to build standard, flat (glass/plastic) enclosures on the sides of bathtubs, running the full length of the tub, in order to prevent the bathroom getting all wet when bathing. (See: FIG. 1/Prior Art/SHEET—1/4)

Due to the standard sizes of bathtubs (including those with combined showers), whose width reaches about 70 cm (only!), the bather is limited already to a “maneuverable space” by placing the “enclosure” on the bathtub side (See: FIG. 1, SHEET—1/4).

This greatly hinders a person's movement of limbs during bathing. Also, these enclosures technically restrict the bathing process, thus lengthening the time spent bathing, causing wasted time, water and electricity in addition to hampering the enjoyment of the bathing process itself.

These enclosures restrict the bather, especially people who are above standard height and weight, but not only for them.

The lack of the expandable enclosure impairs greatly the quality of life for people with physical limitations, bodily handicapped and ill; thus making it very difficult, even impossible, to preserve personal hygiene: washing their bodies and taking care of themselves in an optimal and satisfactory manner. This also limits and in some cases prevents access to providing the needed assistance by a professional (medical) staff or family member, during the bathing.

A similar problem exists also with the senior/elderly population, who often requires assistance to bath and preserve personal hygiene.

Bathing in showers, located in relatively small and narrow spaces, has the same negative and confining implications for the bather, as a result of the lack of freedom to move ones body (due to the enclosures/narrow walls and outstretched door!).

Among the many who suffer as a result of this problem, are many groups of people, including:

Persons above average weight and/or height;

Persons suffering physical handicaps and/or bodily handicaps;

People who require the professional assistance of (medical) staff and/or family, but are prevented from receiving such help due to the closed confinement of the small bathing space. Such as:

Patents suffering from injuries/body paralysis

Elderly requiring assistance, etc.

It should be noted that for many, this is a serious detriment also to their quality of life, and preservation of basic personal hygiene. This has an accumulating effect with consequences to their bodily and physical health.

### B. Description of Prior Expertise

In locating professional literature regarding “prior expertise”, searches were made in libraries and web sites dealing in the patent field. Research was carried out on a number of international web sites and on several levels which touched, directly or indirectly, the subject of “enclosures” existing in bathrooms (mainly baths/showers) and ways to expand the “space” for the bather.

During this research, many hundreds of patents were reviewed, but no patents were found which provided a solution or any kind of referral to this problematic subject.

(In contrast, in the invention which I am presenting there is an optimal solution for this problem.).

However, there were a number of patents which mention “enclosures” in bathrooms, whose main purpose is to prevent the bathroom floor getting wet, etc. (See: Table below)

Below is a Table Listing of Some Patents which Show Indirect Reference to the Subject:

| | Patent | Inventor/ | Publication |
|---|---|---|---|
| Title of Patent | number: | Applicant | Date: |
| Bathtub | JP10314059 | IMAI | 1998 Dec. 02 |
| | | TOSHIO | |
| Living room | JP3147980 | MORITA | 1991 Jun. 24 |
| Equipment for | (A) | TOMOYO, | |
| elderly or | | TOKUDA | |
| Disable | | EIICHI | |
| persons | | | |
| Partition wall | JP11022326 | TANIDA | 1999 Jan. 26 |
| structure | (A) | ISAMU | |
| Partition for a | P3800828.9 | HEINZ | 1988 Dec. 13 |
| corner shower | | GEORG | |
| | | BAUS | |
| Cabinet | DE3324277 | MUELLER | 1984 Apr. 26 |
| shower or | (A1) | HANS- | |
| Shower and | | JOACHIM | |
| Washbasin | | | |
| cabinet | | | |
| Nursing facility | JP4210059 | KASAI | 1992 Jul. 31 |
| | (A) | KENZO | |
| No English title | JP5340114 | TSUZUKI | 1993 Dec. 21 |
| | (A) | MAKOTO | |
| Bathtub with | JP20011869 | NISHIYAMA | 2001 Jul. 10 |
| Wash space | 94 (A) | MASAKI | |
| Space | JP20041377 | SHIKIDA | 2004 May 13 |
| expandable | 29 (A) | HISAYOSHI | |
| bathroom | | | |
| Boundary | JP20012799 | FUKAGAWA | 2001 Oct. 10 |
| struct. | 42 (A) | TAKAHIRO | |
| Between unit | | | |
| bath | | | |
| and adjacent | | | |
| room | | | |

### C. Defining the Invention

The present invention, which is the “Expandable Side Enclosure for Bathtubs/Showers”, is to provide an appropriate solution to prevent restriction and suffering caused bathers in bathtubs and/or showers due to the lack of free body and limb movement required during bathing, in baths with standard enclosures. (See: FIG. 1, SHEET—1/4).

Expandable Side Enclosure for Bathtubs/Showers, presented here, consists (for bathtubs) of at least two doors: one flat door used as an “entrance” to the bathtub, and the second door which has the protuberance throughout its whole width, going in the direction of the bathroom space (see: FIG. 2, FIG. 3, SHEET—1/4).

These two doors are assembled on the outer side of the bathtub and slide on two-way tracks (see: no. 4, FIG. 2, FIG. 3, SHEET—1/4), each one moving on its own track.

The door with the protuberance slides on the outer track.

Due to the ‘protuberance’ in the side-enclosure, the width (and as such the ‘Space’) in the bathtub increases dramatically and can reach up to 25.0 cm (!) and more, per the choice and decision of the bather/consumer (see: FIG. 3, SHEET—1/4, FIG. 4, SHEET—2/4).

### BRIEF DESCRIPTION OF THE DRAWINGS

FIG. 1: Prior Art (SHEET—1/4);

FIG. 2: First Embodiment. (Expandable Side Enclosure for Bathtub). SHEET—1/4;

FIG. 3: The Expandable Side Enclosure ceiling view looking down (SHEET—1/4);

FIG. 4: Second Embodiment. Section (front view) (SHEET—2/4);

FIG. 5: The Expandable Side Enclosure for Bathtubs ceiling view looking down (SHEET—2/4);

FIG. 6: Third Embodiment (Section). SHEET—3/4;

FIG. 7: Forth Embodiment (Section). SHEET—3/4;

FIG. 8: First Embodiment (Section). SHEET—3/4;

FIG. 9: Fifth Embodiment (An Expandable Side Enclosure/Door for Shower). SHEET—4/4;

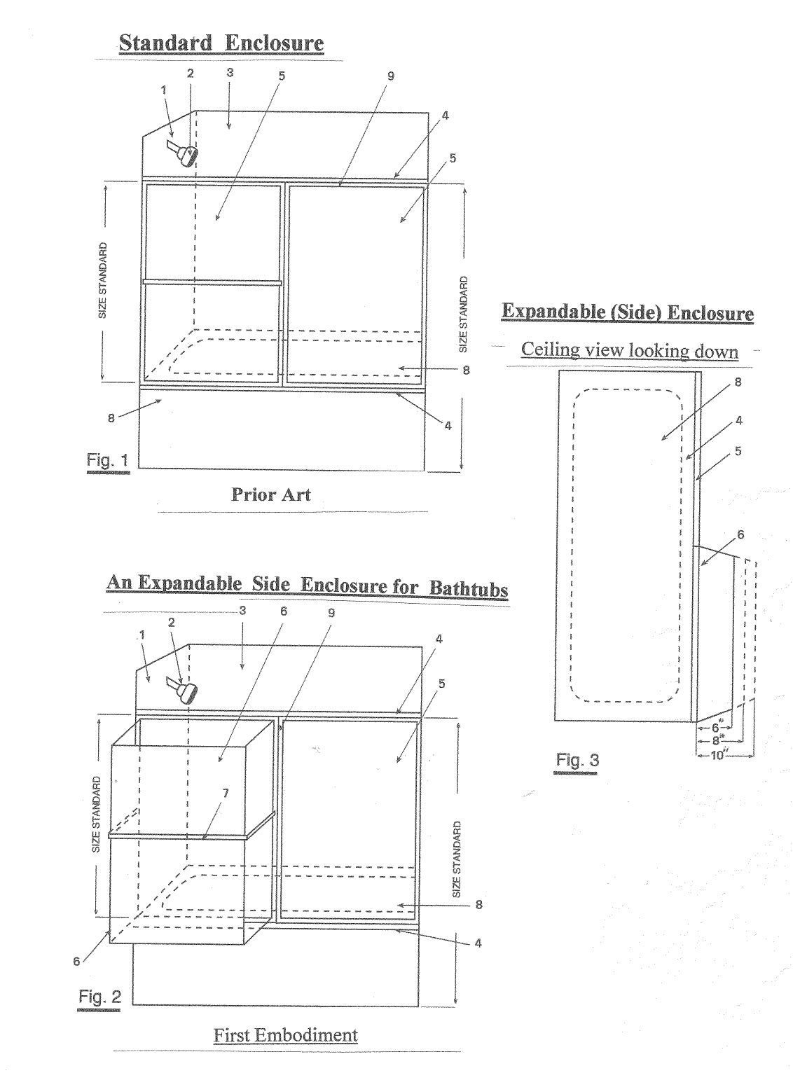

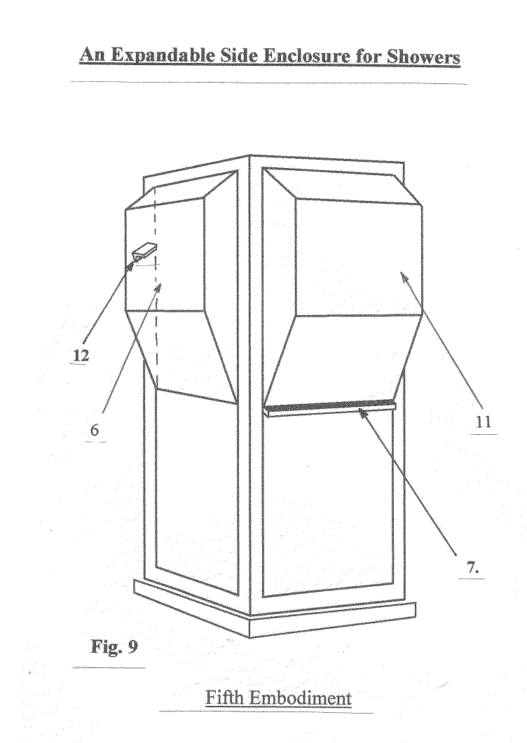

### THE REFERENCES WHICH APPEAR IN THE FIGS. 1-9

(SHEET—1/4, SHEET—2/4, SHEET—3/4, SHEET—4/4):

| | | | |
|---|---|---|---|
| 1, 3 | Wall; | 2. | Shower Head; |
| 4. | Two-Way Double Track; | 5. | Prior Art; |
| 6. | Expandable (Side) Enclosure; | 7. | Rack; |
| 8. | Bathtub; | 9. | Frame/Enclosure; |
| 10. | Section; | 11. | Expanded door |
| 12. | Shelf; | | (Shower) with the |
| | | | protrusion'. |

For added comfort and convenience to the bather, there is installed on the inner side of the ‘expandable’ door a shelf for washing accessories (soap/sponge) at chest height, with easy access. And on the outer side of the door there is installed a towel/shower robe rack, also at an easy accessible height.

Moreover, the expandable enclosure, following the increased bathing space and greater comfort of the bather, has another important advantage: when finishing bathing, the individual can dry off within the space, before leaving the bathtub into the ‘cooler’ bathroom (especially during the cooler seasons: spring, autumn, winter).

Also, this enclosure enables one to provide assistance to the bather during bathing by professional staff and/or family member.

Another advantage to the expandable enclosure is that this won't detract from the bathroom space itself (this is very important for small and narrow bathrooms.)

This is due to the fact that the expandable enclosure doesn't start expanding and protruding until 60 cm-80 cm up from the floor (per model), and thus can be next to the sink (and even protrude above), the bath cabinet, the toilet, etc.

### The Structure of the Expandable Side Enclosure of the Bathtub

The Expandable Side Enclosure—is installed on the side wall of the bathtub, and is built in two parts:

Part A: An Expandable Side Enclosure (glass/plastic) (See: No. 6, FIG. 2, SHEET 1/4): running the full width and height, with the “protrusion” extending out into the bathroom. This enclosure is framed (See: No. 9, FIG. 2, SHEET—1/4) and installed on a two-way double track (See: No. 4, FIG. 2, SHEET—1/4), and can move in both directions (right/left) on the outer track.

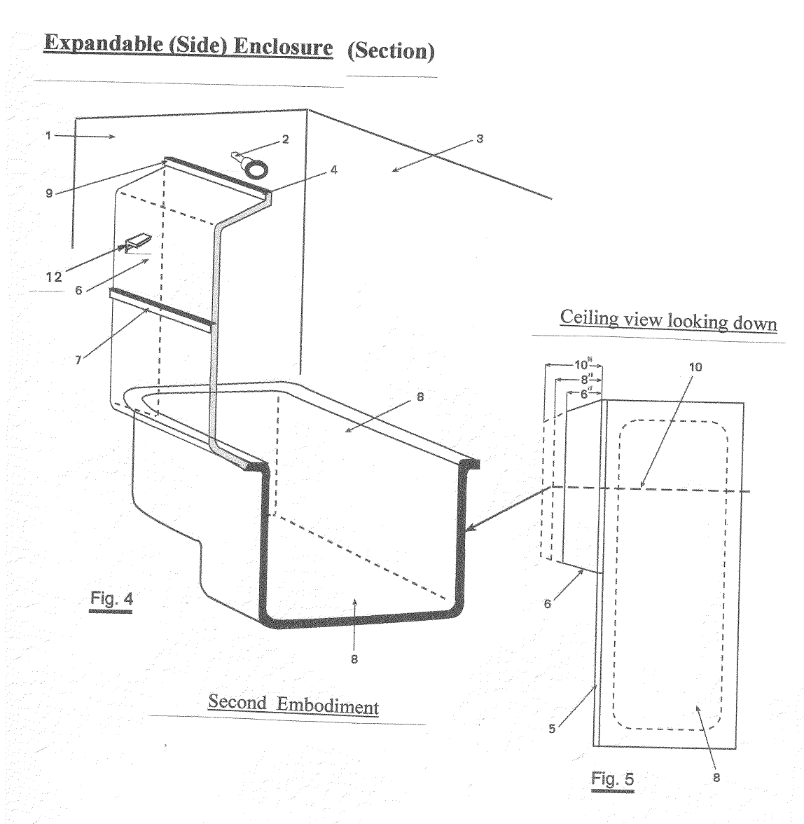

The Enclosure holds a towel/clothing rack (on the outer side of the enclosure) (See: No 7, FIG. 2, SHEET—1/4. FIG. 4, SHEET—2/4), and a shelf for bathing accessories (soap/sponge) on the inner side of the enclosure.

Part B: Prior Art—a standard, flat enclosure framed and installed on the back of the track (inner track) and can move in both directions, used also as an “entrance” to the bathtub (See: No. 5, FIG. 1, SHEET—1/4).

In addition, the expandable door comes in several models, with different ‘protrusion’ angles to each model, and with different sizes, in which the breadth of the ‘protrusion’ is what determines its measurements, per the request of the consumer.

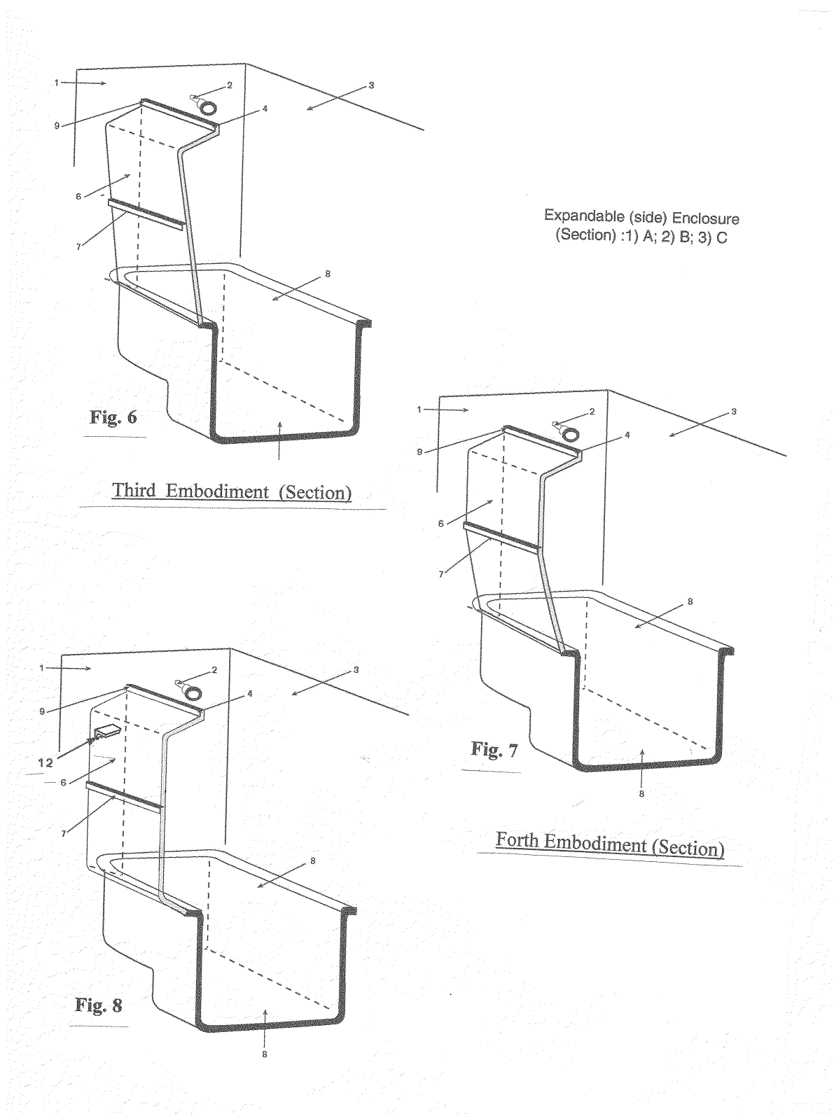

To show examples, four figures are presented showing different types from the long list of enclosures for bathtubs available: (See: FIG. 2; FIG. 4, 8; FIG. 6; FIG. 7).

### Expandable Door/Side Enclosure for Showers

The Shower, like the bathtub, often needs expansion as well in order to improve optimal bathing comfort and, especially in showers which are located in small, tiny spaces.

Showers, per the actual space available, can have instead of the standard, flat door—the ‘expanded’ door with the ‘protrusion’ facing the bathroom open space. Also, it is possible to exchange the partition of the shower for a ‘protrusion’ partition. Of course, in the instance of the shower, the shower door and partition will be for the whole height of the shower. Beginning from the floor and reaching the height of 80 cm-100 cm. they are of standard width and above this begin to expand in the door and partition, like with the bathtub, and can include an “internal shelf” for shower accessories, and a towel/bathrobe rack on the outer side of the door. (See: no. 7, no. 12, FIG. 6, SHEET—4/4).

It will further be appreciated, by persons skilled in the art that the scope of the present invention is not limited by what has been specifically shown and described hereinabove, merely by way of example; rather, the scope of the present invention is defined solely by the claims, which follow.

What is being claimed:

1. Expandable Side Enclosure for Bathtubs (glass/plastic) includes, at least two sliding doors which are assembled into the bath's sides and move on two-way sliding doors, in which one door used as the entrance door is the flat door (running on the inside track), and the second door is assembled along the whole width and faces with the ‘protrusion’ outwards towards the bathroom and slides on the outer track.

2. Expandable Door/Side Enclosure for Shower, according to claim #1, by assembling the expandable door (with the outer protrusion towards the bathroom open space), it is possible to solve the problem of crowdedness also in small showers, to which can be assembled the door as well as the partition of the shower ‘protrusion’, but this time to the full height of the shower starting from the floor, in which the lower part (80 cm-100 cm from the floor) with standard width and above this begins the expansion in the door and partition, like in the bathtub.

3. Expandable Side Enclosure for Bathtubs/Showers, according to claims #1 and #2 the expandable enclosure is essential in providing solutions for medical/geriatric institutions and/or apartments for the senior and the elderly population, whom often require assistance during bathing, thus demanding the need for a more expansive space and comfortable access to the ‘patient’.

4. Expandable Side Enclosure for Bathtubs, according to claim #1, it must be noted that it is possible to change the order of placing the doors on the bathtub's side, per actual needs, in which the bathtub entrance can be set either right or left.

5. Expandable Side Enclosure for Bathtubs/Showers, according to claims #1, #2 and #3, will be equips on the inner side of the expandable door/partition there is a small shelf for bath accessories (soap/sponge) and on the outer side of the door there is a towel/bathrobe rack.
